(19) United States
(12) Patent Application Publication
(10) Pub. No.: US 2015/0153777 A1
(43) Pub. Date: Jun. 4, 2015

(54) ELECTRONIC DEVICE WITH BOTH INFLEXIBLE DISPLAY SCREEN AND FLEXIBLE DISPLAY SCREEN

(71) Applicant: NVIDIA Corporation, Santa Clara, CA (US)

(72) Inventors: Laurence LIU, Kunshan (CN); Richard LAI, Shenzhen (CN)

(73) Assignee: NVIDIA Corporation, Santa Clara, CA (US)

(21) Appl. No.: 14/095,257

(22) Filed: Dec. 3, 2013

(51) Int. Cl. G06F 1/16; G06F 3/041

(52) U.S. Cl. CPC G06F 1/1652; G06F 3/0412; G06F 1/1647; G06F 1/1643

(57) ABSTRACT

Systems and methods for providing a user interface by using a flexible display screen as well as an inflexible display screen. The dual display screens are installed on the same electronic device and may be used to display information simultaneously or alternatively. The flexible display screen can display information in an expanded position and is substantially compacted in size in a retracted position. In response to a user request, the flexible display screen can automatically wind around a rotatable axial connector. The inflexible touchscreen may serve to receive user input with respect to the content displayed on the flexible display screen. An instant size of the flexible display screen can be detected by a sensor and used to adapt a format of the content displayed on the flexible display screen.

### TECHNICAL FIELD

The present disclosure relates generally to the field of electronic display devices and, more specifically, to the field of flexible display devices.

### BACKGROUND

Portable computing devices, such as laptops, PDAs, media players, touchpads, smartphones, etc., have evolved to become more and more sophisticated with faster processing speed and greater data handling capabilities yet in continuously decreasing size. It has been recognized that further downsizing of the portable devices is limited by their display screen sizes that have to be large enough to provide reasonable viewing. Conventionally, display screens on portable computing devices are typically built on glass-containing substrates and thus unbendable or inflexible. FIG. 1 is a diagram illustrating the exterior of a touchpad 100 having an inflexible touchscreen in accordance with the prior art.

Recently, flexible display screens have attracted attention from academic, research and commercial sectors as being a viable approach for satisfying the demand for increasing device portability while preserving reasonable display sizes. Current research and product development in this area have focused on replacing the conventional inflexible touchscreen with a flexible display screen on a portable device. When a portable device or its display screen is not in use, the flexible screen can be bent, rolled in, or folded to a small size so that the user can conveniently carry the device around. When in use, the flexible screen can be expanded to a much greater size to provide a comfortable reading experience to the user. Flexible display screens are in particular useful in the contexts where large view areas are desired and user interactions are infrequent, such as web browsing, reading books and news articles, and watching videos.

However, an interactive flexible display screen, e.g., a flexible touchscreen, naturally flexes when subject to touches. Thus, when frequent user interactions with the portable devices are needed, such as playing a video game or typing documents, an inflexible touchscreen can be a drastically more convenient and efficient user input device that a flexible touchscreen. One approach to solve this problem is to select a relatively sturdy substrate material, or semi-flexible substrate material, to manufacture the flexible touchscreen, which can facilitate user touches. Unfortunately, this inevitably counteracts the ability of reducing the display screen sizes.

Moreover, flexible touchscreens typically have inferior electrical and optical performance over the conventional inflexible touchscreens.

### SUMMARY OF THE INVENTION

Therefore, it would be advantageous to provide a display device that has an expandable display area as well as a sturdy surface to receive user input. Accordingly, embodiments of the present disclosure employ a display assembly for instance for use in a mobile device, including both an inflexible touchscreen and a retractable flexible display screen. The two screens may be used to display information simultaneously and/or alternatively. The flexible display screen can display information in an expanded position and is substantially compact in size when in a retracted position. In response to a user request provided through a soft switch or a physical switch, the flexible display screen can automatically wind around itself and a rotatable axial connector mounted on the housing of an electronic device to extend or to retract. The inflexible touchscreen may serve to receive user input with respect to the content displayed on the flexible display screen. An instant size of the flexible display screen can be detected by a sensor and used to dynamically adapt a format of the content displayed on the flexible display screen. Therefore, a user using a portable device equipped with a display assembly according to the present disclosure can advantageously view electronic information in a large screen and efficiently provide user input through a touchscreen having a sturdy surface.

In accordance with an embodiment of the present disclosure, an electronic display device comprises: (1) a first display component comprising a substantially inflexible substrate and touch sensors, wherein the first display component is configured to display information and to receive user input via the touch sensors; (2) a second display component comprising a flexible substrate and having a display surface, wherein the second display component is windable between a first position in which the display surface is substantially flat and exposed for viewing and a second position in which the display surface is rolled up, wherein the second display component is configured to display information to a user in the first position and is substantially compacted in size in the second position; and (3) a housing configured to support the first display component and the second display component, wherein the housing comprises a compartment for storing the second display component when in the second position. The second display component may comprise touch sensors operable to receive user input when in the first position. The second display component may have a fixed edge coupled to a rotatable axial connector that is supported by the housing; and a free edge parallel to the fixed edge. The second display component may be configured to switch from the first position to the second position along a direction that is perpendicular to the fixed edge responsive to a pulling force applied on the free edge. The substantially inflexible substrate comprises a glass-containing substrate, and wherein the flexible substrate comprises a plastic substrate.

In another embodiment of present disclosure, a computing device comprises: (1) a component board comprising: a bus; a processor coupled to the bus; and a memory coupled to the processor; (2) a touchscreen coupled to the processor and being substantially inflexible; (3) a flexible display screen coupled to the main processor and being retractable from an expanded position to a refracted position in which the flexible display screen is rolled up, wherein the flexible display screen is configured to display electronic information to a user at the expanded position, and wherein further the flexible display screen is substantially hidden from a user at the retracted position; and (4) a housing configured to support the touchscreen and contain the flexible display screen and component board.

In another embodiment of present disclosure, a portable computing device comprises: a bus; a processor coupled to the bus; a touchscreen coupled to the processor and being substantially inflexible; a flexible display screen coupled to the processor and retractable from an expanded position to a retracted position in which the flexible display screen is rolled up; and a memory coupled to the processor. The memory comprises instructions that, when executed by the processor, cause the portable computing device to perform a method of providing a user interface to a user. The method comprises automatically displaying electronic information on the flexible display screen when the flexible display screen is in the expanded position.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a diagram illustrating the exterior of a touchpad having an inflexible touchscreen in accordance with the prior art.

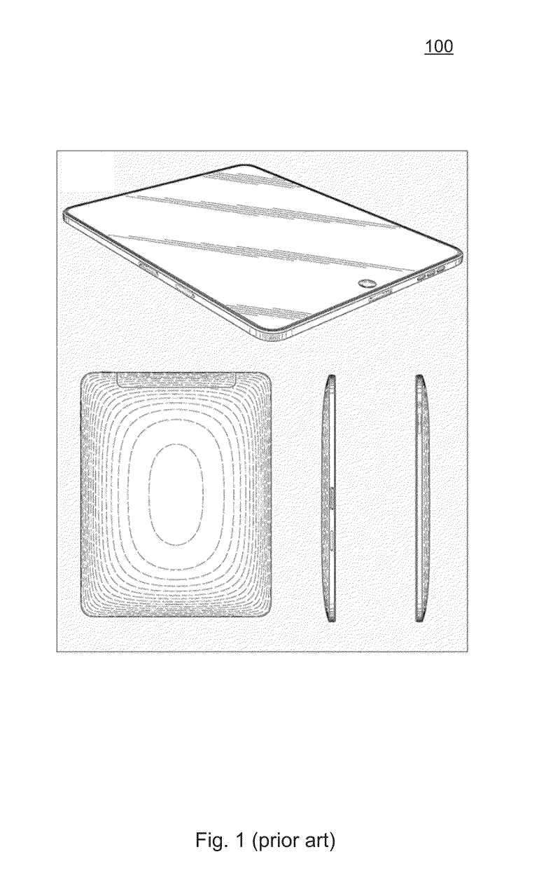

FIG. 2A illustrates an exemplary portable device equipped with an inflexible touchscreen and a retractable flexible touchscreen in an expanded position in accordance with an embodiment of the present disclosure.

FIG. 2B illustrates the exemplary portable device equipped with an inflexible touchscreen and a retractable flexible touchscreen in a concealed position in accordance with an embodiment of the present disclosure.

FIG. 3 illustrates an exemplary rotation mechanism that can drive the flexible screen to scroll e.g., extend or retract, in accordance with an embodiment of the present disclosure.

FIG. 4 illustrates an exemplary computer implemented method of providing a user interface by an electronic device that employs an inflexible touchscreen and a flexible display screen in accordance with an embodiment of the present disclosure.

FIG. 5 is a functional block diagram illustrating the configuration of a computing device that comprises an inflexible touchscreen and a flexible touchscreen in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

Electronic Device with Both Inflexible Display Screen and Flexible Display Screen

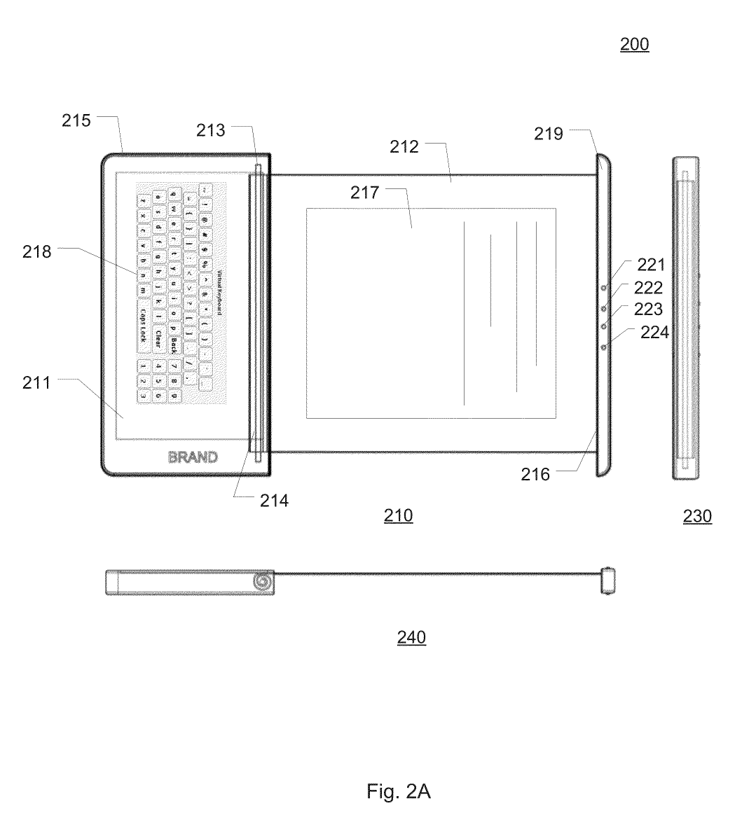

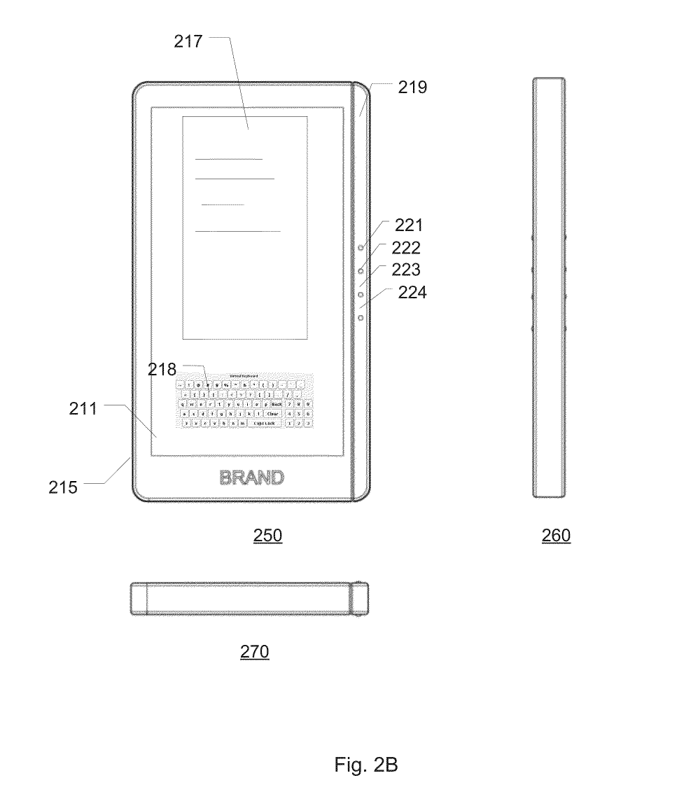

FIG. 2A illustrates an exemplary portable device 200 equipped with an inflexible touchscreen 211 and a retractable flexible touchscreen 212 in an expanded position in accordance with an embodiment of the present disclosure. 210, 230 and 240 respectively provide a front view, a side view and a bottom view of the portable device 200 with the flexible touchscreen 212 in the expanded state. Generally, a user can choose to use the two display screens alternatively or simultaneously for electronically displaying information. The inflexible touchscreen 211 is mounted on the front surface of the portable device housing 215. The flexible touchscreen 212 is rollable around the rotatable axial connector 213 that is mounted in a compartment (not explicitly shown) of the housing 215 designed to accommodate the retracted flexible touchscreen 212. One edge 214 of the flexible touchscreen 212 is attached to the rotatable axial connector 213 and the opposite edge 216 is free in relative to the housing. When in use, the flexible screen 211 can be rolled out to an expanded size (as illustrated in FIG. 2A), e.g., that is bigger than the portable device 200 itself, to display electronic information. When not in use, the flexible screen 211 can completely be rolled in to fit within the compartment (as illustrated in FIG. 2B), thereby becoming concealed by the housing 215 for safe storage.

With both flexible and inflexible display screens installed an electronic device, a user can advantageously make use of the best attributes of each screen type while using a single device, and thereby achieve better user experiences. Specifically, when the electronic device is used for applications where a large viewing area is preferred and infrequent user input is needed, a user can elect the flexible touchscreen to be the active user interface, for example to display videos, news, text, photos. When the device is used for applications where frequent user input is needed, such as playing video games, a user can elect to use the inflexible touchscreen as the active user interface which provides a sturdy surface subject to user interaction via touches.

In some embodiments, the flexible touchscreen is associated with a position sensor that can detect the instant position, and therefore the view area of the flexible touchscreen can be determined. In some embodiments, the flexible touchscreen can be automatically activated for displaying in response to an expanded position being detected, and the inflexible touchscreen may be automatically deactivated in response. In some embodiments, the flexible touchscreen may be deactivated once it starts to scroll in or retract.

In some embodiments, both display screens can remain active at the same time, by default or as instructed by the user. For instance, as illustrated, the flexible screen 212 can be used for displaying the content of a document 217 to the user, while a virtual keyboard 218 and/or scroll bar (not explicitly shown) can be displayed on the inflexible touchscreen 211 to receive user input for instance with respect to the content displayed on the flexible touchscreen 212. In some embodiments, the flexible display screen and the inflexible touchscreen can display the same content contemporaneously and either screen can receive user input during the displaying. In some embodiments, the two display screens can also be used as a unified screen with each displaying a portion of an electronic document, e.g., a webpage.

The flexible screen 212 comprises a flexible substrate, such as a plastic substrate, that can be wound round the axial connector 123 until it fits in or contained within the compartment in the housing. In some other embodiments, the flexible screen may include other suitable flexible substrate material. In some embodiments, electrical adaptors that couple the flexible wires embedded in the flexible screen and the display interface circuitry contained in the device housing can be also disposed in the rotatable axial connector.

In the illustrated example, the rotation of the rotatable axial connector 213 can be driven by an electrical motor, which may be associated with the position sensor and control logic. A user may also be allowed to manually pull the flexible screen out. It will be appreciated that the flexible screen according to the present disclosure may be configured to be retracted in other suitable mechanisms, e.g., manual control, motorized control, or by spring retraction. For example, the flexible touchscreen may be folded into a fraction of its fully expanded size and made concealed in a dedicated compartment inside the housing.

The present disclosure is not limited to any specific dimensions or other geometric aspects of the portable device and the flexible screen. In some embodiments, the flexible screen may be expanded to a size that is 1.5˜2 times greater than the inflexible touchscreen. In some embodiments, the flexible screen can be positioned at a plurality of partially expanded positions for displaying information as well as at a fully expanded position. In some of such embodiments, the format of the displayed content can be adapted automatically responsive to the instant position of the flexible screen. For example, the sizes of the displayed images and characters may be dynamically adjusted in proportional to the instant size of the flexible screen.

In some embodiments, more than one flexible touchscreen can be installed on a portable device and can be used alternatively and/or contemporaneously along with the inflexible touchscreen. In one aspect, the multiple flexible screens may be expandable in different orientations and to different sizes that are perpendicular to each other for example.

In the illustrated example, the edge 216 of the flexible screen 212 is attached to a rigid frame bar 219. The frame bar 219 may bears physical switches, e.g., 221 and 222, which can be used by a user to manually control an optional electrical motor and therefore the position of the flexible screen, such as being fully retracted, fully expanded, or partially expanded. The other physical switches 223 and 224 may be used to control the activation and deactivation of the flexible screen, respectively. The physical switches, 221-224, on the frame bar 219 may communicate to the electrical motor and control logic through flexible wires that are embedded in the flexible screen 212, or attached to the flexible screen 212 along the extending direction.

The present disclosure is not limited to any specific type of a flexible screen. The flexible screen may be based on any suitable technology well known in the art, such as electronic paper or electronic ink, and flexible organic light-emitting diode (OLED) displays. For instance, the flexible screen is manufactured by printing the illuminant elements and associated circuits onto a plastic sheet in a roll-to-roll process. In some embodiments, the flexible screen is equipped with touch and/or proximity sensors and thus capable of receiving user input as well as displaying images and characters. However, in some other embodiments, the flexible screen only functions as a display output device and a user can provide input through the inflexible touchscreen.

The inflexible touchscreen 211 comprises a rigid substrate, which is typically made of glass-containing material. However, it will be appreciated that the inflexible touchscreen according to the present disclosure can be manufactured, fabricated, designed, and configured in any suitable technology that is well known in the art. For example, the inflexible touchscreen can be an active-matrix liquid crystal display (AMLCD), liquid crystal displays, a plasma display, active-matrix organic light-emitting diode (AMOLED), etc. The inflexible touchscreen 211 may include touch and/or proximity sensors that are based on any suitable technology that is well known in the art, such as resistive touchscreen, surface acoustic wave (SAW) touchscreen, capacitive touchscreen, surface capacitance touchscreen, projected touchscreen, mutual capacitance touchscreen, self-capacitance touchscreen, infrared grid touchscreen, etc.

FIG. 2B illustrates the exemplary portable device 200 equipped with an inflexible touchscreen 211 and a retractable flexible touchscreen 212 in a concealed position in accordance with an embodiment of the present disclosure. Diagrams 250, 260 and 270 respectively provide a front view, a side view and a bottom view of the portable device 200 with the flexible touchscreen 212 in the fully retracted position. In this example, the frame bar 219 resembles an edge or bezel of the housing. In some embodiments, once retraction is detected, the display function of the portable device 200 is transitioned completely to the inflexible touchscreen, as shown.

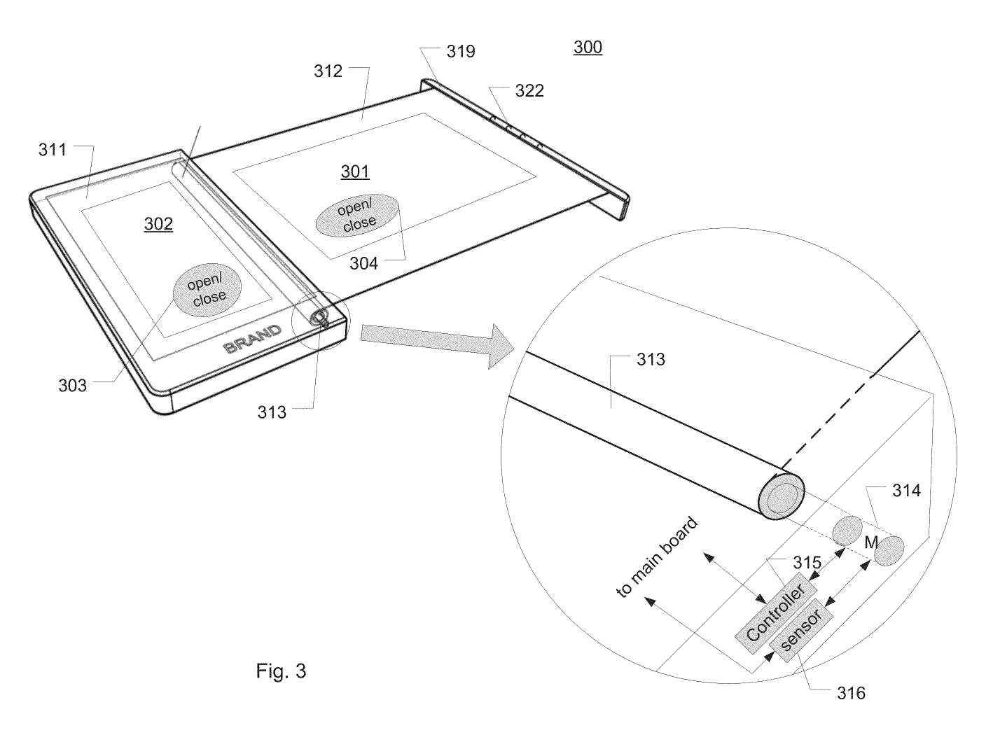

FIG. 3 illustrates an exemplary rotation mechanism that can drive the flexible screen 312 to scroll in accordance with an embodiment of the present disclosure. A rotary motor 314 (or spring) is coupled at an end of the rotatable axial connector 313 and drives its rotation under the control of the control logic 315. The control logic 315 is also coupled to position sensor 316 operable to detect the real-time position of the flexible screen 312. The control logic is controlled by a processing unit (not explicitly shown) disposed in the main electronics board and can also send the status information regarding the sensor 316 and the motor 314 to the processing unit. The motor 314 can be controlled by a physical switch, e.g., 322, that is disposed on the frame bar 319. Alternatively, it can be controlled by a soft switch, e.g., 303 or 304, on a graphical user interface, e.g., 302 or 301.

In some embodiments, the flexible screen can be detached by a user from the associated electronic device. In some embodiments, a flexible screen according to the present disclosure comprises an embedded or built-in processing unit, memory and/or a network circuit, and thus can display data generated thereby.

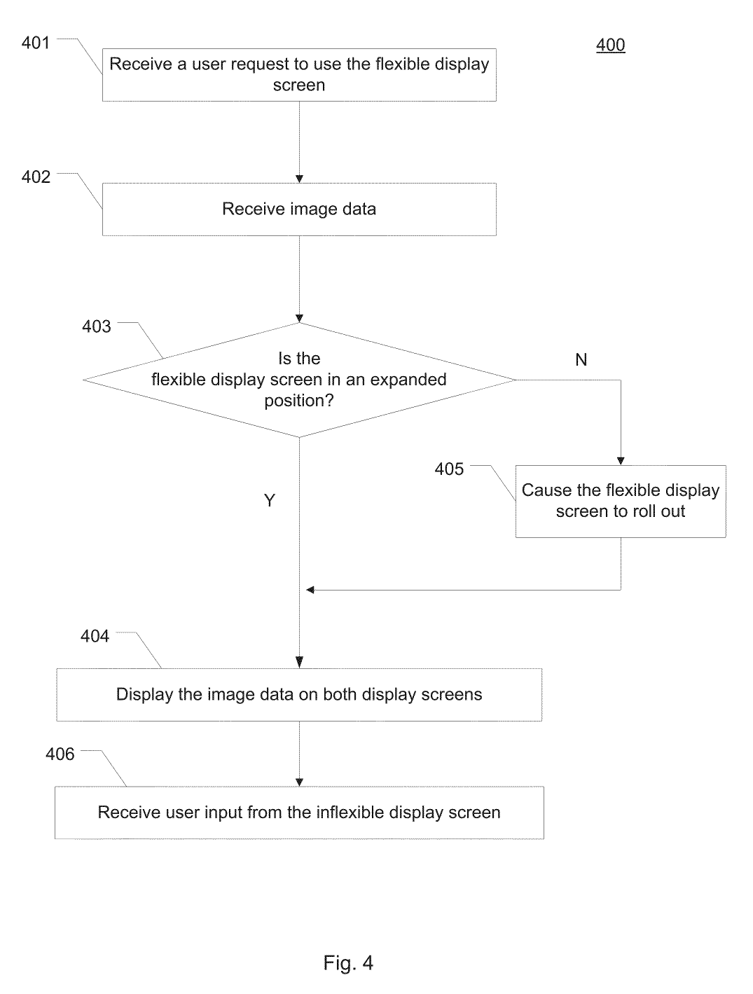

FIG. 4 illustrates an exemplary computer implemented method 400 of providing a user interface by an electronic device that employs an inflexible touchscreen and a flexible display screen in accordance with an embodiment of the present disclosure. At 401, a user request is received to use the flexible display screen. The user request may be put forth through a soft command or a physical switch. At 402, the image data is received for displaying. If it is determined that the flexible display screen is an expanded position at 403, the image is displayed on both display screens at 404. For example, the two screens can display the same content, although the user may probably elect to view the image from flexible display screen. The user can provide user input by touching the inflexible touchscreen, as in 406. If it is determined that the flexible display screen is in a retracted position at 403, the flexible display screen is automatically rolled out at 405, and then displays the image data as in 404.

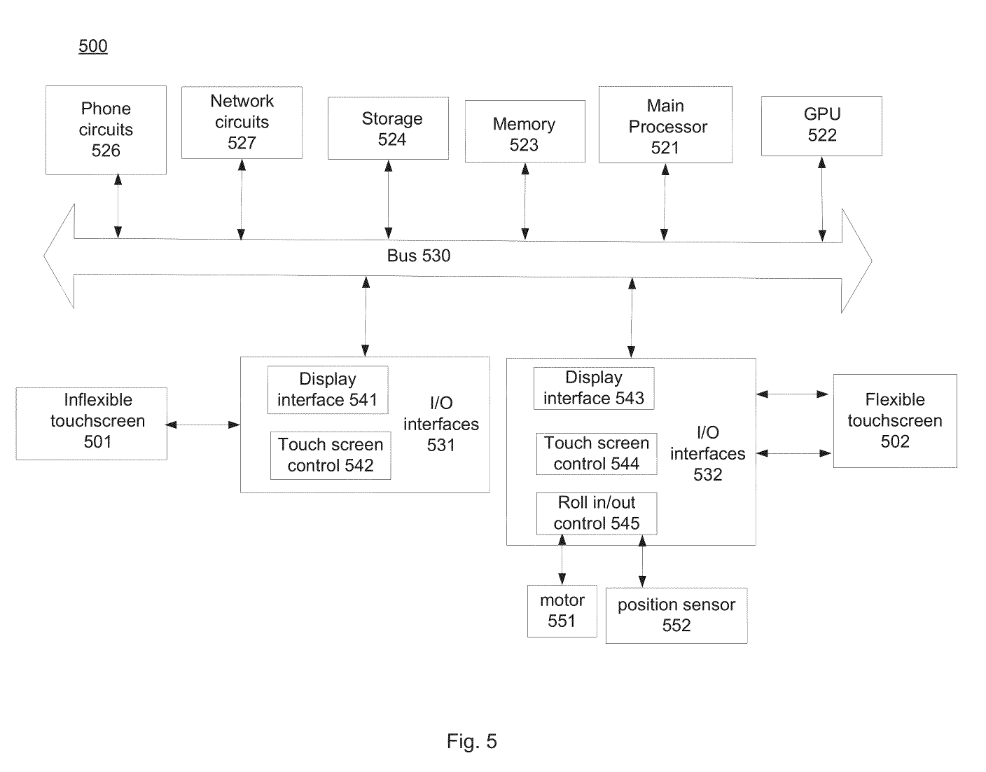

A display assembly comprising both inflexible display screen and flexible display screen in accordance with the present disclosure can be applied in any type of device that uses a display panel, such as a laptop, a cell phone, a personal digital assistance (PDA), a touchpad, a desktop monitor, a game display panel, TV, a controller of a machine, etc. FIG. 5 is a functional block diagram illustrating the configuration of a mobile computing device 500 that comprises an inflexible touchscreen 501 and a flexible touchscreen 502 in accordance with an embodiment of the present disclosure. In some embodiments, the mobile computing device 500 can provide computing, communication and/or media play back capability. The mobile computing device 500 can also include other components (not explicitly shown) to provide various enhanced capabilities. The inflexible touchscreen 501 is coupled to a display interface 541 and touchscreen control logic 542 in accordance with the illustrated embodiment. The flexible touchscreen 502 is coupled to a display interface 543, touchscreen control logic 544, and the roll-in/out control logic 545. The roll-in/out control logic 545 is coupled to a motor 551 that drives the motion of the flexible touchscreen 502, and a position sensor 552 that senses the position of the flexible touchscreen 502. Alternatively, a position sensor 552 can be coupled directly to the motor to detect the status of the motor which can be used to derive a position of the flexible touchscreen 502.

According to the illustrated embodiment in FIG. 5, the computing system 500 comprises a main processor 521, a memory 523, an optional Graphic Processing Unit (GPU) 522 for processing graphic data, network circuits 527, a storage device 524, phone circuits 526, I/O interfaces 531 including display interface 531 to communicate with the inflexible screen 601 and a touch screen control 542, I/O interfaces 532 including an display interface 543 to communicate with the flexible screen 502, a touch screen control 544, and the roll-in/out control logic 545, and a bus 530, for instance.

The main processor 521 can be implemented as one or more integrated circuits and can control the operation of mobile computing device 500. In some embodiments, the main processor 521 can execute a variety of operating systems and software programs and can maintain multiple concurrently executing programs or processes. The storage device 524 can store user data and application programs to be executed by main processor 521, such as video game programs, personal information data, media play back programs. The storage device 524 can be implemented using disk, flash memory, or any other non-volatile storage medium.

Network or communication circuits 527 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 527 can provide wired network connectivity instead of or in addition to a wireless interface. Network interface 527 can be implemented using a combination of hardware, e.g. antennas, modulators/demodulators, encoders/decoders, and other analog/digital signal processing circuits, and software components.

The I/O interfaces 531 and 532 may also provide communication and control between the mobile computing device 500 with other external I/O devices (not shown), e.g. a computer, an external speaker dock or media playback station, a digital camera, a separate display device, a card reader, a disc drive, in-car entertainment system, a storage device, user input devices or the like.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. An electronic display device comprising:
a first display component comprising a substantially inflexible substrate and touch sensors, wherein said first display component is configured to display information and to receive user input via said touch sensors;
a second display component comprising a flexible substrate and having a display surface, wherein said second display component is windable between a first position in which said display surface is substantially flat and exposed for viewing and a second position in which said display surface is rolled up, wherein said second display component is configured to display information to a user in said first position, and wherein said second display component is substantially compacted in size in said second position; and
a housing configured to support said first display component and said second display component, said housing comprising a compartment for storing said second display component when in said second position.

2. The electronic display device of claim 1, wherein said second display component further comprises touch sensors operable to receive user input when said second display component is in said first position.

3. The electronic display device of claim 1,
wherein said second display component comprises: a fixed edge coupled to an rotatable axial connector that is supported by said housing; and a free edge parallel to said fixed edge, and
wherein said second display component is configured to switch from said first position to said second position along a direction that is perpendicular to said fixed edge responsive to a pulling force applied on said free edge.

4. The electronic display device of claim 3,
wherein said rotatable axial connector is coupled to an electrical motor configured to drive said second display component between said first position and said second position, and
wherein said second display component, when in said second position, is substantially disposed beneath said first display component.

5. The electronic display device of claim 1, wherein said second display component, when in said first position, has a viewable area that is twice as much as a viewable area of said first display component; and wherein said first display component is configured to be automatically deactivated when said second display component is in said first position.

6. The electronic display device of claim 1, wherein said substantially inflexible substrate comprises a glass-containing substrate, and wherein said flexible substrate comprises a plastic substrate.

7. A computing device comprising:
a component board comprising a bus; a processor coupled to said bus; and a memory coupled to said processor;
a touchscreen coupled to said processor and being substantially inflexible;
a flexible display screen coupled to said main processor and being retractable from an expanded position to a retracted position in which said flexible display screen is rolled up, wherein said flexible display screen is configured to display electronic information to a user at said expanded position, and wherein further said flexible display screen is substantially hidden from a user at said retracted position; and
a housing configured to support said touchscreen and contain said flexible display screen and component board.

8. The computing device of claim 7,
wherein said flexible display screen comprises an organic light-emitting diode (OLED) comprising touch and proximity sensors and a flexible substrate, and
wherein said flexible display screen is configured to receive user input via said touch and proximity sensors.

9. The computing device of claim 7,
wherein said flexible display screen comprises a first edge and a second edge that are parallel to an edge of said housing,
wherein said first edge is coupled to a rotatable axis that is supported by said housing, and
wherein said second edge is coupled to an frame bar that is substantially inflexible, wherein said frame bar resembles an edge of said housing when said flexible display screen is in said retracted position.

10. The computing device of claim 7, wherein said rotatable axis is coupled to an automatic rotation drive operable to cause said flexible display screen to roll and unroll between said expanded position and said retracted position in response to a user request.

11. The computing device of claim 9, wherein said flexible display screen and said rotatable axis are detachable from said housing by a user, wherein said flexible display screen comprises embedded logic comprising another memory and another processor, and wherein said automatic rotation drive comprises an electronic motor.

12. The computing device of claim 10, wherein said frame bar comprises a control switch coupled to said automatic rotation drive and configured to control said automatic rotation drive responsive to a user interaction with said control switch.

13. The computing device of claim 9, wherein said flexible display screen and said touchscreen are configured to simultaneously display same content, and wherein said touchscreen is configured to receive user input with respect to said same content.

14. The computing device of claim 7, wherein said flexible display screen, when in said expanded position, has a display size that is approximately 1.5 times greater than a display size of said touchscreen.

15. A portable computing device comprising:
a bus;
a processor coupled to said bus;
a touchscreen coupled to said processor and being substantially inflexible;
a flexible display screen coupled to said processor and retractable from an expanded position to a retracted position in which said flexible display screen is rolled up; and
a memory coupled to said processor and comprising instructions that, when executed by said processor, cause said portable computing device to perform a method of providing a user interface to a user, said method comprising automatically displaying electronic information on said flexible display screen when said flexible display screen is in said expanded position.

16. The portable computing device of claim 15 further comprising a sensor configured to detect a position of said flexible display screen, and wherein said method further comprises determining a position of said flexible display screen based on a detection signal provided by said sensor.

17. The portable computing device of claim 16, wherein said method further comprises automatically displaying electronic information on said touchscreen responsive to a determination that said flexible touch screen is in said retracted position.

18. The portable computing device of claim 17, wherein said method further comprises automatically adapting a format of electronic information displayed on said flexible display screen based on a detected position of said flexible display screen.

19. The portable computing device of claim 15, wherein said method further comprises:
rendering to display of a graphical user interface (GUI) on said flexible display screen; and
receiving user input provided through user interactions with said touchscreen.

20. The portable computing device of claim 15, wherein said method further comprises rendering to display a graphical user interface (GUI) on said flexible display screen or said touchscreen, wherein said GUI comprising a visual object configured to control a position of said flexible display screen in response to a user request.
